(19) United States
(12) Patent Application Publication
(10) Pub. No.: US 2017/0183243 A1
(43) Pub. Date: Jun. 29, 2017

(54) Systems and arrangements for mitigating environmental damage caused by storm water carried pollution

(71) Applicants: Doug Reitmeyer, Leander, TX (US); John Demming, Oakdale, CA (US)

(72) Inventors: Doug Reitmeyer, Leander, TX (US); John Demming, Oakdale, CA (US)

(21) Appl. No.: 14/545,115

(22) Filed: Mar. 26, 2015

(51) Int. Cl. C02F 1/00; E03F 7/02; G05D 7/06; C02F 1/28

(52) U.S. Cl. CPC C02F 1/008; C02F 1/001; C02F 1/28; E03F 7/02; G05D 7/0623; C02F 2209/008; C02F 2209/001; C02F 2101/20

(57) ABSTRACT

A pollution mitigation system is disclosed. The system can include a valve forming a passage the valve installable to form an orifice in a storm drain retention chamber that passes storm water into a conduit of a storm water management system. The valve having a stem connected to a closure member that can plug the orifice. The valve can have a spring loaded actuator that can move the closure member into a closed position. The system can also include a node such as a wireless sensor node or a mote that has sensors, a transceiver, an antenna, a microcontroller, memory, an energy source and at least one output to control movement of the closure member via the preloaded actuator. The node can have an output that provides the stimulus to the preloaded actuator to cause the preloaded actuator to move the closure member to a position that obstructs the passage in response to either the sensor or a transmission from a mobile telephone such as a cell phone or a smartphone.

### CROSS-REFERENCE TO RELATED APPLICATIONS

This application claims priority to a provisional application No. 61/970,734 under U.S.C §119e which was filed on Mar. 26, 2014 entitled System and Arrangements for Mitigating Environmental Damage Caused by Storm Water Carried Pollution. U.S. Provisional Application 61/970,734 is hereby incorporated by reference.

### FIELD OF INVENTION

The present disclosure relates to systems and methods for stopping, filtering and mitigating the entry of pollutants into storm drain systems, sewers and waterways.

### BACKGROUND

Historically, most municipalities in the United States and worldwide have not viewed drainage from rain water as particularly hazardous to the health of humans and animals. Consequently, most existing storm drainage systems collect runoff and channel it directly into the waterways or creeks, streams, rivers, seas, and eventually our oceans. However, in recent years, the public has realized that such runoff picks up and carries hazardous particulate, chemicals trash and solids such as plastics cigarettes and toxic automotive lubricants which can become dissolved or mixed into our water supply. The result being that our public waterways, i.e. rivers, seashores, harbors and oceans have become polluted with hazardous chemicals, trash, soil particulate, organic matter, phosphates, bacteria and anything that our society discards in an area that freely drains into a waterway and watershed collection areas.

Plastics are of special concern as a pollutant as plastics degrade very slowly or have a potential lifetime amounting to hundreds of years. Further, plastic floats and plastic is easily transported by water flowing in, over and out of watersheds. Plastics are generally not broken down by bacteria in the environment and are not easily dissolved by any liquids or chemicals found in the environment. Over time, storm and other liquid runoff moves and places tons and tons of plastic remnants to creeks, rivers, river banks, lakes, seashores and locations in bodies of water, ultimately and most notably end up within ocean vortex currents, the largest of which is known as the “Pacific Trash Vortex”. These plastic remnants are particularly hazardous to wildlife as they are often eaten by animals or animals become entangle in them resulting in the illnesses and death of millions of animals annually. It can be appreciated that as the world population, industry and land development continues to grow, defoliation and the grading of soil increases the amount of soil and chemicals, including fertilizer, herbicides and pesticides, petroleum products that are carried into our waterways and domestic water supplies via storm water drainage.

Roads and parking lots or paved surfaces that support automobile traffic typically become coated with significant pollutants such as petroleum products, heavy metals and volatile organic compounds under normal traffic conditions and in particular when accidents occur. When normal rain or snowfall occurs, these toxic pollutants are picked up by storm water, sprinkler systems, outdoor vehicle and area washings, watershed runoff and mixed therewith and such pollutants eventually contaminate the bodies of water that receive them. Such contamination has become a significant environmental issue in many areas and greatly contributes to the impairing our waterways as defined by the Environmental Protection Agency (EPA). In addition, a significant amount of sediment and debris such as organic waste, bottles, cans, Styrofoam, cigar and cigarette butts, etc., tend to float and is easily swept away by storm water and other liquid runoff. Some runoff carried debris is heavier than water, and some debris has the tendency to float. Even today, storm water systems are unable to effectively and efficiently filter both types of debris, for either ordinary or elevated flow conditions.

In the past, numerous methods and products have been employed in attempts to prevent sediment, trash, fuels, lubricants, plastics and other matter from flowing into our waterways. One such attempt includes placing filters on inlets, such as curb inlets to the storm water collection systems. Bales of hay and similar products such as straw wattles are often placed around or in front of inlets in an attempt to filter out sediment and other solids flowing into storm water drainage systems. Other attempts have used permanent mesh grates, stones wrapped in chicken wire and fabrics to filter contaminant and/or pollutants from storm water and other runoff before it reaches open waterways.

In addition, metal filters and screens have also been used without great success. Such filter systems generally are placed in a temporary fashion and held in place with weights or straps. Such a configuration is less than perfect for many reasons. Other metal and metallic screen filters that are permanent in nature have been used but such configurations are expensive, hard to install and remove, and to maintain. Such systems cause a major problem when they become clogged resulting in flooding or standing water on roadways causing great potential for vehicular accidents which are very costly to society and more particularly for the government.

A workable filtering system that prevents contaminants from entering our waterways and drinking water needs to be easy to implement and maintain. Further, to be workable, the system must be adaptable to a wide variety of different types and sizes of storm drain inlets due to the wide variance in drain types and sizes. Adapting a system for each configuration and size can be cost prohibitive. Systems exist for filtering storm water runoff that are effective to some extent in removing debris from storm water and in removing certain other pollutants, such as hydrocarbons. For example, U.S. Pat. No. 6,080,307 discloses a storm drain insert that contains a basket for the collection of debris as well as a canister that contains a hydrophobic, compliant, oil-absorbent copolymer material that is said to be effective in removing oil from runoff proximate to a storm drain. Additional systems for removing pollutants such as heavy metals from storm water have been commercialized for example by companies such as Fabco Industries Inc. http://www.fabco-industries.com/

Filtration equipment and devices commonly referred to as “storm water filters”, “storm water inserts”, “drain inlet inserts” or “catch basin inserts” now find increasing use as a Best Management Practice (BMP) to meet environmental regulations. Such devices and other water treatment equipment are commonly installed in site-built or pre-cast concrete catch basins, commonly referred to as drain inlet basins, either by suspending the filtration equipment, or a component thereof, from a grating or cover support frame surrounding an open top of the drain inlet basin, or by attaching an appropriate metal framework to interior wall surfaces of the basin to provide support for the equipment or components to be deployed within the basin interior space. Because of the relatively small space within most basins, installing runoff filtration systems is often an expensive, difficult and challenging task.

Ideally, water entering a storm water drainage pipe or storm water sewer line should be free of solids and toxic contaminants. Early storm water filters removed solids from the water before the water flowed into the catch basin. These filters were made of a porous material and were located at or above grade level, which were readily visible. A very early version of this method simply used stacked hay bales around the periphery of the storm drain grate. The filters were typically placed horizontally on the top of the grate or, like the hay bales, stood up vertically in a circle above grade level, surrounding the grate. Water flowed freely through the filter and into the catch basin. Solids were captured by the filter. Over time, the solids built up on the filter, thereby impeding the free flow of water through the filter. As a result, the collected water flooded the area surrounding the storm drain inlet.

More modem catch basin inserts have been developed that can be installed below grade so that the solids are filtered from water without impeding the flow of water through the catch basin and into the storm drainage system. Additionally, such filters were designed to be readily removed from the catch basin for dumping when filled with sediment and debris. Some examples of these types of filters are U.S. Pat. No. 5,575,925 (Logue, Jr.), and U.S. Pat. No. 6,086,758 (Schilling et al.), U.S. Pat. No. 6,093,314 (Wilson et al.), U.S. Pat. No. 6,059,964 (Strawser), and U.S. Pat. No. 6,045,691 (McDermott). These designs, while an improvement over the above-ground filters, suffer from several drawbacks. For instance, the Logue design comprises a filter bag with flaps. However, when the grate is lifted, the bag often falls into the catch basin spilling the filtered pollutants. The other references teach function by adapting rigid frames for catch basins of specific size or shape.

An effective storm water sedimentation and debris filtration system requires a configuration that is simple to install and to service, since the collected sedimentation and debris will have to periodically be removed from the system. Water treatment media such as filtration media will also have to be periodically inspected and replaced. In any type of water treatment system, there is a trade-off between the amount of storm water that the system can effectively process and the efficiency of the water treatment. In other words, for a given size storm water carried contamination control system, the greater the amount of storm water to be processed, the less effective the treatment can be. Accordingly, it is advantageous to be able to design a system that is scalable for the anticipated flow rates in order to optimize water treatment efficiency and longevity of the system.

A need exists for an improved system and process for processing sediment and debris laden storm water that can be optimized for anticipated conditions. There is a need for an efficient and effective system for filtering all kinds of pollutants and debris before it enters public waterways under all or most conditions, that is inexpensive to deploy and cost-effective to service. Accordingly, the need remains for a storm drain system that addresses the short comings of the prior art. The problems identified above are in large part addressed by the systems, arrangements, methods and media disclosed herein.

### SUMMARY OF THE INVENTION

The disclosure herein relates generally to system methods and arrangements for mitigating storm water carried pollution at the entry point of where storm water enters into storm drains. Some embodiments relate to a storm drain entry point monitoring and control system that allows for first responders to monitor conditions at the entry point and control different aspects of the system, both in real time.

Some embodiments via individual nodes, operated by downloadable application for a smartphone can provide distributed control of a storm water drainage system. The system provides monitoring and control features for first responders (such as closing valves at a storm drain) where such control can limit certain control functions to certain personal and can require multiple responders to agree on the control aspects before they are implemented. In some embodiments a high ranking official can override all other first responder's control inputs. Prior to implementing control inputs, first responders can acquire and review data associated with the storm water entry point (such as video, runoff composition data, flow rate, watershed statistical information, etc.) and thus an individual or automated monitoring system can take immediate remedial action prior to a catastrophe without being on site or alternately when they arrive on site. Additionally, computer programs can either take control and/or make recommendations for handing over the control to humans trained and authorized to make storm water command and control decisions. The disclosed system allows for the mitigation, lessening and/or even the elimination of environmental damage caused by toxins and pollutants entering our environmentally sensitive waterways.

The disclosed system can include a trash and/or sediment collection drawer that can be inserted in a narrow curb inlet where the drawer has an orifice or a cutout for a valve assembly that allows for easy insertion and removal of trash and sediment from the drawer. After the drawer is inserted into the curb inlet, the valve assembly can be placed into the basin, through a manhole above the basin or bottom of the basin in which the drawer is placed as well. The drawer assembly can have a cutout area such that the drawer can travel in and out of the basin area without regard to or interference with the valve assembly.

The system can include a trash and sediment collection device that is configured like a drawer or other configuration which can be inserted and removed from a catch basin. The catch basin can include tracks, rails or a drawer mount for supporting the drawer as it is placed into the basin where the drawer can be inserted and removed while guided on side mounted rails. Drawer can have wheels or rollers or a surface that reduces friction such that the drawer can be easily slid into and out of the basin.

Such a configuration makes for quick and easy placement and removal of the collected trash and storm water carried sediment and contaminants. The drawer or trash/sediment/contaminant collection device can have a sensor that acts as a security device 158 and can indicate when the system 100 or valve 102 is installed and/or removed and such data can be used to activate or deactivate various features and functions of the assembly which may include hardware/software GPS tracking as a theft deterrent. The system can include many additional sensors that can provide real time data as to the position of the drawer or trash collection device, valve assembly and the conditions or parameters of the water flowing through the system to the authorities and authorized personal such as first responders. Data can be read not only on site, but also by any compatible device in range of communication.

The system can include filtering and overflow features to filter out debris and sediments and can report if they become plugged or clogged and can include failure provisions such that they still provide adequate drainage in the event the filters become clogged. Thus the system can prevent debris, soil, trash, and sediment from entering the storm drainage system and have a failsafe mode when overloaded with flow or clogged by the contaminants entering the system with control override provision to prevent otherwise dangerous flooding conditions.

In some embodiments the system can include at least one test port and/or at least one evacuation port. The test port can be used to test for what chemicals have either been filtered or prevented from entering the storm water system when the valve is closed. In some embodiments one evacuation port can be configured to allow for the vacuuming of solids such as litter, paper plastic cardboard and organic waste by a vehicle equipped with a large vacuum and a second evacuation port can be configured for both sampling and evacuating solid or liquid waste from the system. The size of the outlet pipe for the solids can be many times the diameter of the liquid evacuation port as a pump could be utilized to evacuate liquid from the system.

The disclosed device provides a remedy to the noted shortcomings of conventional storm drain inlet filtering devices and systems. The disclosed device is formed of corrosion resistant and sturdy metal components such as a polymer, aluminum, galvanized steel or stainless steel, which will last many years in the harsh environment in which storm drain systems are subjected to.

It is an object of this invention to provide an easily engaged and disengaged storm drain inlet trash collection drawer or basket, filter/treatment technologies and valve which will encourage widespread use and deployment. Yet another object of the devices are to provide storm drain inlet filters and control systems which from all appearances are permanently installed to discourage theft and vandalism.

Still further, it is an object of the disclosed invention to provide such an easily deployable storm drain system which when widely employed, will help reduce and possibly eliminate trash and dangerous substances from entering and impairing Earth's waterways.

### BRIEF DESCRIPTION OF THE DRAWINGS

Aspects of the invention will become apparent upon reading the following detailed description and upon reference to the accompanying drawings in which, like references may indicate similar elements:

FIG. 1 illustrates a storm water mitigation system;

FIG. 2 depicts a system having a piston above a drawer;

FIG. 3 illustrates a system having a piston below drawer;

FIG. 4 depicts a flangeless valve system; and

FIG. 5 illustrates a trash drawer usable with a valve system

### DETAILED DESCRIPTION OF EMBODIMENTS

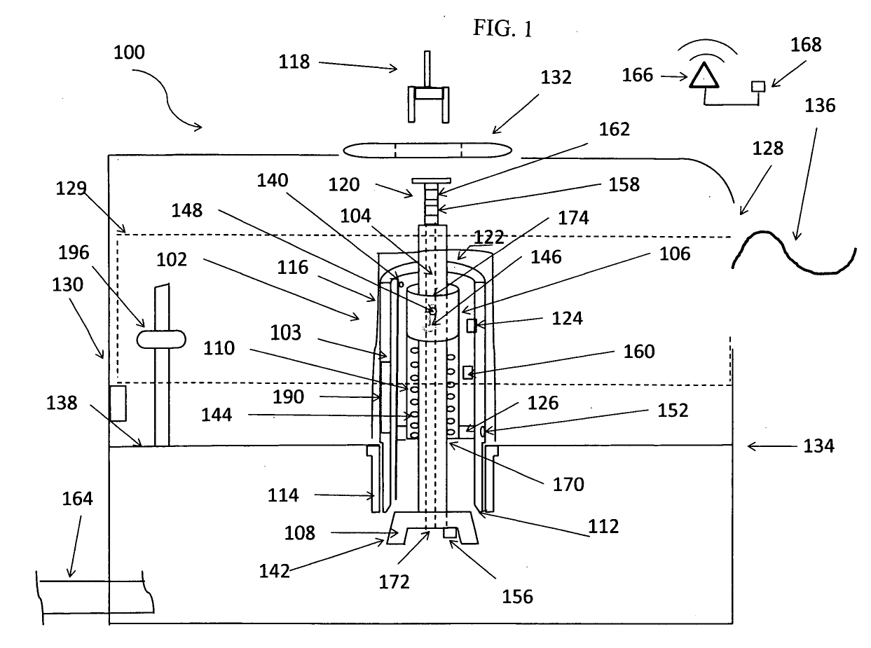

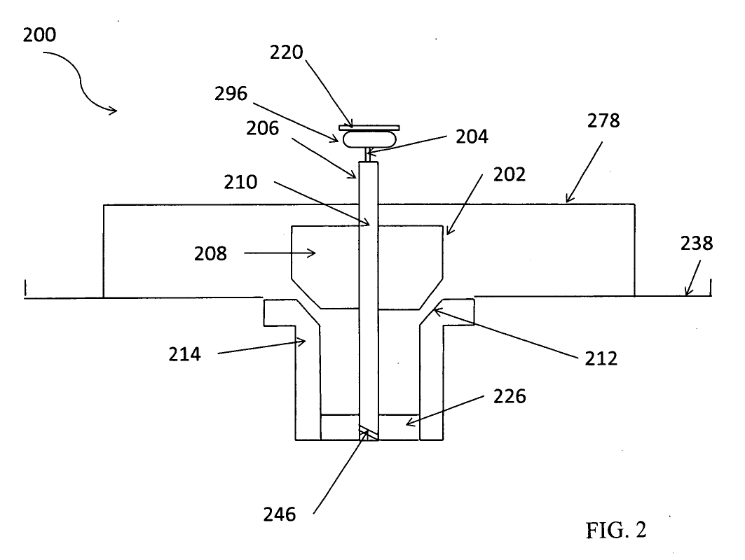

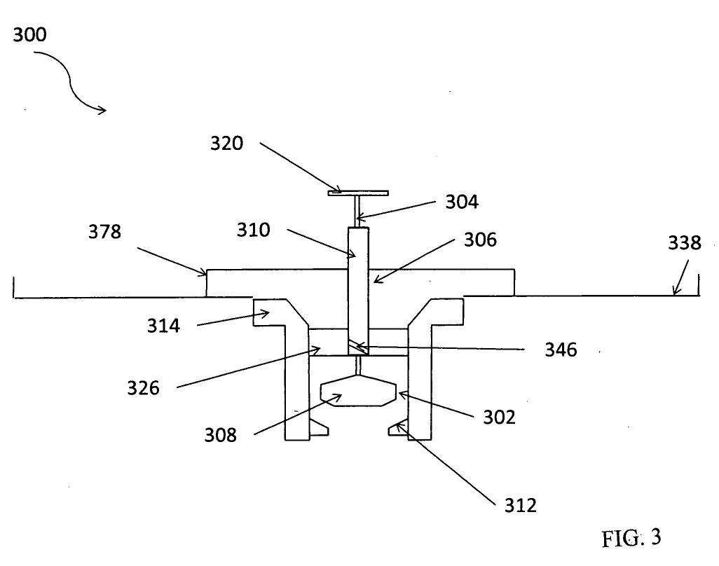

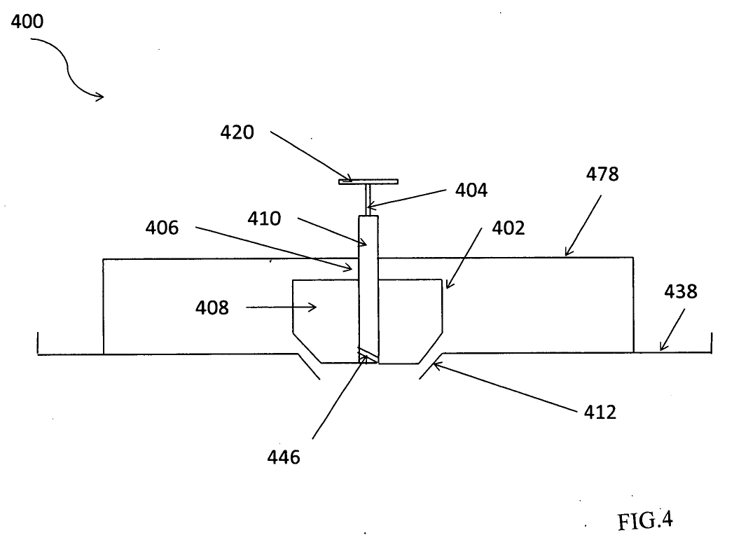

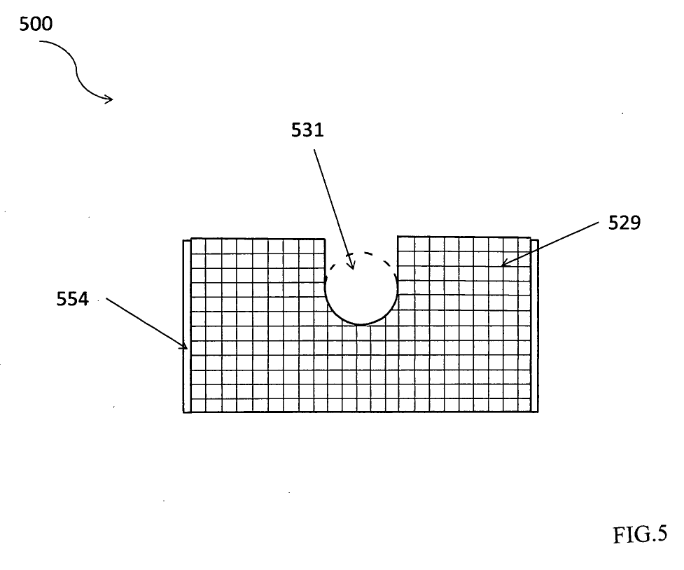

The following is a list of functional components for the disclosed storm water pollution mitigation system 100, 200 and 300
FIG. 1
102—Valve assembly
104—Valve stem
106—Actuator
108—Valve piston (Movable member or movable obstruction)
110—Valve guide
112—Valve seat
114—Mounting flange
116—Filter assembly
118—Key/Tool
120—Key receptacle
122—Overflow relief
124—Sensors
126—Valve guide mount
128—Curb inlet
129—Trash drawer
130—Drawer mounts/Track
132—Manhole cover
134—Catch basin
136—Storm water runoff
138—Drawer
140—Evacuation/sample port
142—Piston Seal
144—Spring
146—Positioner slot
148—Pin
150—Valve position retainer
152—Install sensor
154—Rollers/sliders
156—Processor/transceiver
158—Security device
160—RFID modules
162—Antennae
166—Wireless network
164—Outlet pipe
168—Remote processor/application
170—Stem seal
172—Rotational seals
174—Positioner cover
178—Valve guide positioner
FIG. 2
200—Storm water pollution mitigation system
202—Valve assembly
204—Valve stem
206—Actuator
208—Valve piston
210—Valve guide
212—Valve seat
214—Mounting flange
226—Bottom valve guide mount
227—Top valve guide mount
238—Drawer
246—Positioner slot
278—Valve guide mount
FIG. 3
300—Storm water pollution mitigation system
302—Valve assembly
304—Valve stem
306—Actuator
308—Valve piston
310—Valve guide
312—Valve seat
314—Mounting flange
318—Handle
326—Valve guide mount
338—Drawer
346—Positioner slot
FIG. 4
402—Closure member
404—Stem
406—Actuator
408—Sensors in sensors in closure member
410—Valve mount via actuator
412—Valve seat in pan
420—Manual actuator
446—Actuator positioner
438—Floor
478—Basin or tray
FIG. 5
554—Tray sides
531—Valve
529—Tray

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims. The descriptions below are designed to make such embodiments obvious to a person of ordinary skill in the art.

While specific embodiments will be described below with reference to particular configurations of hardware and/or software, those of skill in the art will realize that embodiments of the present invention may advantageously be implemented with other equivalent hardware and/or software systems. Aspects of the disclosure described herein may be stored or distributed on computer-readable media, including magnetic and optically readable and removable computer disks, as well as distributed electronically over the Internet or over other networks, including both wired and wireless networks. Data structures and transmission of data (including wireless transmission) particular to aspects of the disclosure are also encompassed within the scope of the disclosure.

The interaction of components above provide a pollution mitigation system. Generally the system can include a valve body that forms a passage out of the catch basin 34 or subsurface storm water catch basin. The valve can be installable and removable and placed within or proximate to an orifice in the catch basin 34. The passage or orifice can allow for the movement of water carrying pollutants out of the catch basin and into an outlet conduit. The valve body can retain a stem that is connected to a closure member that can obstruct the passage out of the basin 34. The valve can also include an actuator preloaded by a spring or a charge or gravity. The preloaded actuator can be connected to the closure member. The preloaded actuator can be biased to keep the closure member in a normally open position.

In some embodiments the preloaded, pre-loadable or prebias-able actuator mechanism can be pre-biased to multiple settings such as an open setting, a locked open setting, a closed spring pressure based setting, a locked closed setting and a regulatory setting. The actuator in the regulatory setting can regulate a height of water in the chamber above the valve such that floating debris is substantially prevented from passing through the valve body and out of the basin. The valve can be disposed below the storm water catch basin such that minimal water is retained in the storm water catch basin a predetermine amount of time after storm water runoff ceases to enter the storm water catch basin. The valve and/or the basin 34 can include a sensor node or mote that includes a plurality of sensors, a transceiver, an antenna, a microcontroller, memory, an energy source and can have an output that can provide a signal to activate the preloaded actuator.

The output signal to the preloaded actuator can cause the preloaded actuator to move the closure member to a position that obstructs the passage such that when a pollutant or foreign substance is detected by one of the sensors the basin can retain the pollutant preventing it from entering the storm system conduit. In some embodiments the sensor node can also receive transmission via wireless network from other nodes, a mobile phone, or radio transmitter and close the passage in response to receiving such a transmission. The node can be part of a wireless sensor network including a wireless sensor network that is compliant with and configured as a multi-hop wireless mesh network. The node can have multiple sensor inputs each of which can activate the closure of the passage. Some sensors may not actuate the closure mechanism but may perform other functions. For example one sensor might detect the presence of water and activate the node, activate sensors or unlock preloaded actuator.

Sensors of the system can be configured to detect the presence of one of water, a petroleum based substance, a heavy metal, chemicals found in cigarette butts, plastics, household chemicals, de-icing chemicals, chemicals found in vehicles such as antifreeze, and any chemical listed by the EPA as a pollutant, chemical agents of interest to the NSA and our military. The sensors can be chemical agent sensors such as use in airport screenings, Ion-mobility spectrometry type sensor and a high-performance liquid chromatography type sensor and a mass spectrometry type sensor such as those used to by the US government to obtain military intelligence. The transceiver can be configurable to communicate with other electronic devices a wired or wireless protocol to include an IEEE 802 compliant protocol, Bluetooth, GPRS, Wi-Fi, a cellular type communication network and to communicate via satellite communications including receiving Global Positioning System (GPS) information.

In some embodiments an application can be downloaded onto a mobile platform such as a laptop, a tablet or a smartphone platform where a first responder using this wireless platform can monitor sensor outputs and can activate the closure of the valve. The memory at the node can be used to store data at a node and each node can relay sensor data from each node it receives until the data reaches desirable locations in the network thereby reducing power and long communication links here-to-for required to obtain information throughout a municipality. Some of the sensors can be image sensors that performing imagery defined materials intelligence in connection with chemical defined materials intelligence. Such imagery analysis can measure ions and can analyze pixels and pixel arrangements to identify a composition of one substances passing through the valve, some possibly suspended in storm water.

Many processes disclosed herein can be implemented with a software program. The software programs described herein may be operated on any type of computer, such as personal computer, server, etc. Any programs may be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet, intranet or other networks. Such signal-bearing media, when carrying computer-readable instructions that direct the functions of the present invention, represent embodiments of the present disclosure.

The basin or valve can include a run off sample retention chamber to retain a sample of runoff after the basin completely drains. In some embodiments the sample retention chamber can be at a location of high water level location (basin full), a mid-water level location and at a location that is lowest in the basin where he heaviest matter would be most likely to settle.

Each of the chambers can have a sample extraction conduit such that a testing entity could evacuate a sample from the chamber for testing and evaluation. A removable filter can be place proximate to the orifice to catch and or absorb pollutants and can be place proximate to one or more sensors such that the sensor can generate information associated with the removable filter. Sensors can also sense and report a position of the valve closure mechanism. The removable filter can also include a unique identifier, agents that don't absorb water but absorb chemicals or liquids other than water. The filer can have or even disperse an agent that absorbs, neutralizes or disperses a pollutant. The dispersal can be activated in response to the detection of a predetermined condition or parameter.

Referring to FIG. 1, a removable, easy to maintain, storm water pollution mitigation system 100 is disclosed. The system 100 can include a trash drawer (drawer) 129 that accepts and filters trash either blown into a basin or carried via storm water or other liquid runoff. Drawer can be manufactured as a “cage” or “trap” that has an opening on the end that faces a curb inlet where it prevents escape of trash that it receives. It can have a gate or flexible fingers that prevent escape through its opening similar to a trap. It can be enclosed on all other sides to prevent the escape of the trash and have a door that can be opened after the drawer is slid out via the curb inlet and emptied possible by a garbage truck while it travels its assigned route. See FIG. 5 for more details.

A valve assembly (valve) 102 that is capable of opening and closing based on a user setting and in response to an actuator 106 which can be controlled locally or remotely. When the valve 102 is in the closed position it can stop or block pollutants or undesirable matter from entering a storm water system and thus prevent toxins and pollutants from entering our public waterways.

Storm sewer inlets, such as curb inlet (“inlet”) 128 provides an aperture or orifice for the entrance of storm water into an underlying storm drain system. Curb inlets such as curb inlet 128 are typically employed where curbs and sidewalks are constructed parallel to roadways. Conventionally, catch basins, such a catch basin 134 will catch larger debris before it can enter underlying drainage outlet pipes such as outlet pipe 164. Debris that accumulates in the basin 134 can be accessed and removed via manhole by removing manhole cover 132. However, conventional catch basins do not, and cannot catch or filter smaller debris and cannot stop liquid contaminants from entering a storm sewer system and thereafter our public waterways.

In accordance with the present disclosure, a removable pan or drawer 129 can have a debris collection configuration, chemically specific filter, diaper, neutralizers, chemically reactive substances and testing mechanisms such as those found on multi-way test strips, and a unique identifier. Below the drawer 129 can be a pan 138 that secures a valve 102 with a filter 116 surrounding the valve like a sock. The entire system 100 can be installed in below-grade catch basin 134. Catch basin (“basin”) 134 can have sidewalls, a floor and cover. Outlet pipe 164, sewer pipe or conduit can extend away from one or more of the sidewalls of basin 134. Outlet pipe 164 is often mounted a particular distance above the floor of basin 134. Basins are typically square, rectangular or cylindrical with one or more sidewalls, a floor and top. When a sufficient amount of liquid accumulates from a rain shower or event such as accidents, car or vehicular washing(s), accidents involving liquid containers or for other reasons, runoff will move or carry liquids, semi-solids and solids such as trash, oils, heavy metals and debris into basin 134 via inlet 128, through and into trash drawer 129 and its filter if it has one, through the filter 116, through the valve assembly 102 and into the bottom of the basin 134 and out of the basin 134 via outlet pipe 164.

The system 100 can include a removable tray or drawer 129 suspended within the catch basin 134 on drawer mounts 130. The drawer mounts 130 can act a retaining system to facilitate easy removal of the drawer 129 for maintenance purposes. Drawer mount 130 allows the drawer 129 to be easily and “effortlessly” removed from and inserted into basin 134. The mounts 130 and/or the drawer 129 can include wheels balls, slides or rollers to facilitate the ease of insertion and removal of the drawer 129 from the basin 134. In some embodiments prior to removal of the drawer 129 from the basin 134, the valve 102 can be removed from the drawer 129 via the manhole. Removal of the valve can reduce the height dimension of the drawer assembly 129 allowing the drawer assembly 129 to be small enough to pass through inlet 128 such that it can be slid into and out of the inlet 128 on drawer mounts 130. The valve 102 can be received by and retained by a valve mounting flange 114 that can be mounted proximate to an orifice in the bottom of drawer 129. The mounting flange 114 can have splines or a retaining mechanism that prevents the valve 102 from being easily removed • and from rotating in relationship to the mounting flange 114 or pan 138 particularly when a user rotates the actuator 106 to open or close the valve 102. The surface between the valve 102 and the mounting flange can be sealed by various methods such as accurate machining, an 0-ring, a sealant, or a polymer washer.

When the valve 102 is assembled to the pan 138 and the piston 108 of the valve 102 is in the closed position, the system 100 can prevent runoff 136 from exiting the basin and entering open waterways. When the piston 108 is in the open position and runoff is flowing, a filter assembly 116 (shown as a “sock” around the valve 102) can filter and retain containments and pollutants at the valve 102 thereby preventing these toxins from traveling into drain outlet 164 and thereafter public waterways.

Although a curb inlet 128 configuration is shown, in some embodiments the pan 138 can be configured to drop into a basin with a flush mounted or raised grate where pan 138 would be suspended below the grate above the bottom of a the basin. Flush mount grates above basins are commonly found along city streets and sidewalks. In some embodiments, the drawer mounts 130 and drawer 129 can be telescopic to allow one to adjust the dimensions to fit nearly every catch basin 134. Filter assembly 116 can surround valve 102 to filter solids, absorb and or treat other contaminants from getting past the pan 138 and entering the outlet pipe 164 that exits the basin 134. Regardless of the type of inlet 128, the runoff collection and mitigation system 100 can prevent undesirable contaminates and/or polluted water from entering into public waterways and even drinking water by filtering, absorbing and/or treating and/or blocking flow via actuation of the valve 102.

The drawer 129 can be supported by tracks or slides that have an inner edge that extends inward from the basin 134 walls into an interior of the basin 134 or basin. The drawer mount 130 can be fabricated in the shape of an L or a J to form a ledge that will support the drawer 129. Drawer mount 130 can be made from a corrosion resistant material that is sufficiently rigid to provide support for, and hold the drawer 129 in place within basin 134. Water retention, filtration and treatment equipment, or components thereof, can be affixed to drawer 129. Outside corners of drawer 129 or rollers/sliders can mate with drawer mount 130. Edges of drawer 129 can include a member that reduces friction when the drawer 129 is inserted and removed. The mating edges can be placed along the perimeter edge of one drawer 129 that engages the ledge. The drawer 129 can be inserted through a standard curb inlet 128 and the drawer mounts 130 can be suspended appropriately in relation to the drawer 129 and the catch basin 134. Note that storm sewer components come in many different sizes and the disclosed system can be configured in many different sizes. Also note that the parts of the system are or may not be drawn to scale in relationship to one another.

The drawer 129 can have a strainer or filter 116 suspended above it which has a Coanda type tilted wire wedge wire type screen. Filter 116 can be sized to filter, absorption and/or treatment particles of a predetermined size and can include chemicals and other matter that will absorb liquids and/or chemicals other than water that may enter the system 100 and/or treat or neutralize the environmental damaging characteristics of any storm water or other liquid carried pollutants. The system 100 can have an overflow relief 122 to allow for adequate drainage when the normal passage and/or passage via the filter assembly 116 becomes obstructed or the amount of water collected exceeds the capability of the normal filter or drainage passageways.

If it is determined that filter 116 needs cleaning or replaced via observation or sensors, filter 116 can be replaced and the drawer 129 and interior of the basin 134 or chamber can be cleaned with the use of an external vacuum device, such as those found on vacuum trucks. The filter 116 can also have an RFID module 160 or utilize a similar automated identification technology where placement removal and location of the filter 116 triggers notification of such via a connected device, thus, when filter 116 (and/or valve 102) is removed from a vehicle for placement at a site, sensors can detect movement or placement of and identify the filter 116 and correlate a time/location of placement removal, transit, cleaning and testing which can be automatically tracked and recorded by sensors at various locations such that filter status data can be used to identify when and where the filter is, when and where it was serviced and when and where pollutants were captured by the system 100. Thus, when the filter 116 is removed, the location and time of removal can be automatically logged by the processor/transceiver 156 at the valve 102 thus, providing seamless chain of custody information. Such data can be utilized to locate polluters.

In some embodiments the filter 116 can be formed and can have receptacles such as loops in a collar to hold the filter 116 in place in relationship to the valve assembly 102. The filter 116 can be made of a single piece of geotextile nonwoven fabric rolled into a cylinder in some embodiments. The valve assembly 102 or body of the valve assembly 102 can have overflow apertures located on the upper portion of the assembly 102 to provide a relief when the system 100 becomes clogged or cannot process the amount of runoff it receives during heavy rainstorms.

The drawer mount 130 that supports the drawer 129 can form a ledge within basin 134 and thereby provide a place to mount and secure the drawer 129 and a means to guide the motion of the drawer 129 when it is inserted, removed or adjusted to the desired location. The filter 116 can be made of a fabric material and can be place like a “sock” over the valve assembly 102. The filter 116 can be a sleeve that is fitted over the valve assembly 102 and could be made from a fabric or a flexible wire frame. Filter 116 can also be made from a foam material or a fabric material that filters and/or absorbs and/or treats specific liquids also having the option to block unwanted particulate. Depending on the target pollutant, the media could filter, neutralize, treat or perform any combination thereof and may be open cell foam for bacteria, nutrients, heavy metals or hydrophobic fabric which can filter hydrocarbons, any of which may be used. Filters 116 implemented by the disclosed system 100 can include processes that filter, neutralize, treat and be tailored to capture, treat or remove oil(s), trash, debris, hazardous chemicals and sediment. When the valve assembly 102 is removed via the manhole opening, and the drawer 129 is pulled, inspection personnel can periodically inspect the condition of the system 100 including the storm water treatment media(s).

Drawer mounts 130 can be mounted to the sidewalls of catch basin 134 to provide a support frame adapted to slidably receive drawer 129. During insertion, the drawer 129 can be held with handle 170 and can be tipped relative to the horizon during insertion and when almost fully inserted and as the front edge of drawer 129 clears the wall of basin 134 proximate to inlet 128, the front edge of the drawer 129 can be lowered drop down onto the drawer mounts 130 and into the basin 134 where it becomes parallel with the floor of the basin 134 or angled down to accommodate drawer and mount 130. In other configurations, the drawer 129 may be more like a basket and be lifted vertically for cleaning and/or replacing filter, chemical absorption and/or treatment materials. Regarding removal, handle 170 can be grasped to lift the front edge of the drawer 129 either straight up or at an angle above the bottom of inlet 128 prior to pulling and sliding the drawer 129 from the basin 134. Depending on the size of the inlet 128, removal of the drawer 129 may or may not be possible either before or after removal of the valve 102 via manhole 132.

Valve 102 can be a “poppet” type valve which includes a cylindrical body with numerous slots 190 around its surface, piston 108, valve stem 104, valve guide mount 126, valve seat 112, actuator 106, and positioner slot 146. Valve guide mount 126 can retain valve guide 110, which retains valve stem and piston concentric with valve seat 112. Actuator 106 can control the position and motion of valve stem 104 and thus the position of the piston 108. Actuator 106 can be configured in five different modes: open, secured open, closed, secured closed and regulating mode.

In regulating mode the actuator 106 applies a predetermined force on the piston 108 where the piston is biased in a closed position but will open when a sufficient head of water occurs above the piston 108. In this configuration flooding or undesirable back up is prevented while floating debris of chemicals will never make it past the valve because as the head of water lessens the valve will close. In some embodiments, the regulator mode can have filtered or unfiltered weep holes that still prevent standing water. In a two valve embodiment (not shown) a second valve can be placed in regulating mode such that when the first valve malfunctions or the filter clogs, the valve in regulating mode can provide a bypass to prevent flooding on the watershed or roadway.

The regulating process can also be accomplished by a float 196 or bubbler system where when the float reaches a certain height it opens the valve to let runoff pass through the system 100. Such a control configuration can also be used as a failsafe system such that if a filter of valve gets plugged or clogged, prior to water backing up on a roadway and/or flooding a watershed, a specific level of water will move the float and open a relief valve. This control system can operate much like a toilet fill valve in that the float can move up and down on a tower or can be mounted on an arm with a linkage to a flapper valve wherein when the float reaches a certain height it opens the valve. Not all of the mechanisms and linkages are shown regarding how the float 196 would open and close valve 102 however this type of regulating process is known in the art.

Valve guide 110 can ensure a linear motion of the piston 108 as it moves in relation to the valve 102 and the valve seat 112 to open and close passage through the orifice in the bottom of the drawer 129. Actuator 106 which can control the position of the piston 108 can be implemented in many embodiments such as manual operation or automated operation/programmable control, as standard local or remote valve control is a well-known art and all known knowledge and teaching of valve control can be applied to the disclosed actuator 106 and valve assembly 102. In some embodiments the actuator 106 can be spring or adjustable force, threads, a pin and slot, diaphragm assisted, a piston, and/or motor or gear actuated to name a few.

In some embodiments the body or frame of valve 102 can have one or more openings that occur below the bottom of or underside of drawer 129 such that liquid will not be retained in/by the drawer 129 and the system 100. Valve 102 can include a valve seat 112 where, when in the closed position, piston 108 will be sealing by compressed contact with valve seat 112. The piston 108 and valve stem 104 and movement thereof can be retained by valve guide 110 which can be retained by valve guide mount 126 to thereby keep valve components 102, 104, 108, 116 in a substantially concentric relationship position in relation to valve seat 112.

Piston 108 can be a manufactured with a corrosion resistant rigid or semi-rigid core with conforming, flexible resilient sealing surface to mate with valve seat 112. In some embodiments piston 108 can have a core that is manufactured as cast metal or other material(s) into a disk with a surface overlay of polyurethane based or other flexible substance to form a resilient sealing surface. The polyurethane can be molded over the disk at least in the area where the piston 142 engages the valve seat 112 when the piston 108 is in the closed position. The polyurethane, rubber like or other flexible material based substance can form a soft, forgiving surface to mate with the valve seat 112 even in the presence of debris that separates the piston sealing surface from the valve seat by a half inch or less.

In some embodiments valve stem 104 can be formed from a rod or tube and can have a retaining pin 148 protruding or projecting perpendicular therefrom or perpendicular to the length of the stem 104. The pin 148 can slide or ride in positioner slot 146 in the valve guide 110. In some embodiments positioner slot 146 can be cut in a sidewall of valve guide 110. Thus, a vertical path of the positioner slot 146 allows the valve stem 104 to move the piston 142 from an open to closed position or vice versa. The positioner slot 146 can have both vertical components and horizontal components (X and Y axis components) that form a path which the stem 104 and piston 108 will follow. In some embodiments, horizontal or X axis components of positioner slot 146 allow the valve stem 104 to be “locked” or “latched” in an open, closed or regulating position as the valve stem is rotated in various Y or horizontal positions. Turning or rotating valve stem 104 via a key 118 and key receptacle 120 can rotate or move pin 148 such that Pin 148 enters an X axis oriented portion or horizontal portion of the slot 146.

In some embodiments the positioner slot 146 can have horizontal and vertical component(s) (X and Y direction) where the piston becomes unseated if fully open and at a position where valve spring or other force mechanism 144 has a predetermine force on piston 108 via stem 104, and third, at a position of being locked closed. In this configuration when the valve stem 104 is rotated, the pin 148 can ride in the slot 146 where the Y or vertical component of the slot 146 via the pin 148 can pull the piston 142 via the stem 104 closer to the seat 112 thereby making the piston 142 place significant pressure on the seat 112. Such a configuration can provide a mechanical advantage as the pin 146 places pressure on the sealing surfaces as it moves up in relationship to the valve guide 110 when rotated in relationship to the valve guide 110.

In addition the slot 146 can have one or more detents, recesses or over center latching mechanisms or structures that will hold the stem 104 and piston 108 in a desired particular position. Thus, a latching mechanism positioner 146 can hold or lock the piston 108 and valve stem 104 in various positions in relationship to the valve seat 112 or valve body 102 or can lock the position of the spring or other operating mechanism in relationship to piston and the valve guide such that a predetermined head of water or weight of the water present above the piston 108 will move the piston away from the seat thereby reducing the pressure created by the head of water. It can be appreciated that the valve stem 104 can rotate in relationship to the piston 108 such that the rotational force required to latch the piston in a particular position does not depend on rotating the piston 108 in relationship to the valve seat 112.

Alternately described, after a spring pulls the piston 108 upward such that it engages seat 112, the user can rotate the stem 104 which can move the pin 146 in a horizontal (Y axis) direction via the positioner slot 148 thereby compressing the piston 104 tighter to the seat 112 without requiring the piston 108 to rotate in relationship to the seat 112. Such a configuration allows for a robust seal with torque on the stem 104 and avoids scoring that can occur on the sealing surfaces when abrasive debris is present between the sealing surfaces. Sealing arrangements such as o-rings, cup seals or rotational seals 172 and 174 can prevent leakage of fluids into the actuator and between the valves stem 104 and the piston 108 such that contaminants suspended in fluid can interfere with system operation or fluids can get past the system.

In some embodiments actuator 106 can be a tube with threaded end caps to retain a spring and/or other force producing mechanisms. The positioner slots 146 can be fabricated or cut into the wall of the tube. A valve guide cover can be embodied as a sealing cap to the tube to prevent debris from entering the valve guide 110. The end caps can be threaded into the valve guide and can have a shaft seal to prevent water from entering valve guide 110. Likewise to prevent fluid from getting past the valve 102, rotational seals 172 such as O-rings, cup seals of flat seals can be place between the valve stem 112 and piston 108 to allow the stem 104 to rotate in relationship to the piston 108 yet prevent fluids from exiting valve 102 via the valve stem-piston connection.

Valve spring 144 can hold valve stem 104 and piston 108 in an open, closed, intermediate or regulating biased position. Valve spring 144 and/or other force producing mechanism can be retained between the valve stem 104 and the valve guide 110 in various ways known in the art such that it is easy to replace. In some embodiments positioner slot 146 can have notches or can be configured in a J shape such that if the valve stem 104 is pushed down and rotated, pin 148 will be caught by the over-center position formed by the end of the J thereby holding the piston 108 open under the pressure of spring 144 which holds pin 148 at the top end of the J shaped slot.

In some embodiments actuator 106 can be designed such that it has a spring that can provide a force that is sufficient to close the valve 102 or piston 108 during maximum water flow conditions of under a maximum head of pressure as determined by rainfall data. It has been determined that a stainless steel spring with a spring force of 25 pounds can adequately close an 8 inch piston by providing ˜½ PSI which may hold back a column of water approximately 14″ in height. In other embodiment actuator 106 can have a vacuum or flow assist mechanism or can have a two stage control system where the weight or momentum of flowing water can be used to assist in closing the valve 102.

Other positioners 146 can be utilized such as one of many cam follower mechanisms commonly used in the retractable ball pen industry. Such a cam follower design can have one or more slots and protrusions for an actuating cam that when the valve stem 104 is repeatedly pushed down, it combines rotation with the up or down movement to provide a means of opening and closing the valve 102 via the position of piston 108. In some embodiments that piston 108 can be set as a position which is not “open” or “closed” but rather can be adjusted to allow a precise amount of pressure to control flow, to relieve a certain amount of retained head pressure in response to specific or particular conditions at any given time and in real time. It can be appreciated that although the actuator 106 and/or positioner is shown and described as located above drawer 129, any part of the valve 102 can be located above or below drawer 129 as long as drawer 129 and its associated pan 138 fully drains and does not retain fluid for a significant amount of time after storm water or other liquid runoff ceases.

In some embodiments, the piston 108 is located below the bottom of the drawer 129 to prevent the retention of liquid in the drawer 129. It can be appreciated that in order to be able to slide the drawer 129 into and out of the inlet 128 the Z dimension or height dimension of the drawer 129 with mounting flange 114 will be on the order of, but not limited to 4-6 inches, or the height of the storm drain opening. Otherwise the drawer 129 could not be slid into a standard curb inlet 128. After or before the drawer 129 with a flange 114 is slid into curb inlet 128 the valve assembly 102 can be inserted into the flange 114 via the manhole 132 by removing a manhole cover.

Valve assembly 102 can fit snugly into mounting flange 114 which can create a liquid tight seal 142 to prevent escape of fluids there. A seal 142 such as an O-ring can be used to seal the assemblies. The outer diameter of the valve assembly 102 can be slightly smaller than the inner diameter of the valve assembly 102 and a matching taper or chamfer can be manufactured between the valve 102 and flange 114 such that the valve 102 is easily removable but securely retained to the flange 114 and can prevent fluid from passing between the flange 114 and the valve 102. The pan can be created to incorporate a sealing surface for valve 102, thereby eliminating the need for flange 114. Installed sensor 152 can detect when valve is assembled to the insert and a detection signal can be used to activate the sensors or detect if the valve 102 has been removed. The processor 156 can include a GPS sender/receiver and thus the system can determine when a valve 102 is stolen and where it has been taken to such that it can easily be retrieved. In some embodiments a contactless sensor such as a Hall Effect sensor can be utilized as the install sensor 152.

After installation of the valve 102 into the flange 114, via the manhole cover 132 or access hole, piston 108, and the opening to, or outlet of valve 102 can be below the pan and the drawer 129 thereby allowing the liquids filtered and contaminants captured by the drawer 129, filter and pan and eliminating the retention of water and the presence of stagnant water in the pan. Preventing the retention of liquids by the system 100 will promote a healthier environment and avoid harmful phenomena such as the breading of bacteria and bugs such as mosquitos that can carry among other things, the West Nile virus.

Valve 102 can have an overflow relief 122 to allow liquids to bypass the filter 116 in the event that liquid begins filling the drawer 129 potentially backing up on a watershed and/or roadway. Based on flow calculations and filtration rates, the system can be designed to slow the drainage rate of the system 100 to a predetermined rate that will provide maximum filtration. However the overflow 122 can prevent water from pooling on a watershed or roadway causing dangerous conditions and potentially deadly consequences.

In some embodiments the parameters of the spring or other force mechanism can be designed such that the valve will close in the presence of full flow through the valve. In other embodiments the spring or other force creating mechanism can be designed such that a predetermined head of pressure on the piston opens the valve. Such a configuration would only open after the portion of the basin above the pan fills with runoff. Such a system provides beneficial results as typical pollutants and debris will float above the valve and filter and not reach the filter and valve and obstruct the passageway during times of high runoff. The spring strength or other mechanism force can cause a regulation of the head of pressure required to open the valve. Using the equation force equals pressure multiplied by area, the appropriate spring force or other force causing mechanism requirement can be calculated. The actuator can have an adjuster to adjust or allow selection of the force where more of less pressure can be applied to cause the piston/valve to open sufficiently to maintain a predetermined height of water over the valve. With systems 200 and 300, a float can be utilized to open the valve upon the raising of water levels beyond a predetermined height and such can be utilized to maintain any specific maximum water height even under extreme weather conditions.

System 100 can include a port 140 that can be used to both sample fluids and evacuate fluids present in the valve 102. The port 140 can include an outlet pipe 164 extending through the valve 102 or valve stem 104 with an inlet orifice near the valve seat 112. The port 140 can be used to extract fluid samples near the valve seat 112 to determine what contaminants may exist near the sealing surfaces. Such a determination might want to be made as a test or to take a sample of water entering the storm drainage system after passing through the filter 116 or after a chemical spill has filled the valve casing. Port 140 can also be used to evacuate pollutants out of the valve 102 casing prior to opening the valve 102. After a sample is acquired, where either a solid or fluid is evacuated, the location where the sample was acquired can be identified and sent to a lab without the need to remove the valve 102.

A portion of the outside of the valve 102 can be tapered to center the valve 102 into the flange 114 as it is installed. A rubber washer or gasket or other sealing mechanism can also be placed on the flange 116 and/or on the outside of the valve 102 to engage adjacent components and create a seal that prevents the leakage of fluids into the basin 134. Valve 102 can also have a flange that determines the depth at which valve 102 is inserted into the flange 114. Valve 102 can be configured in a variety of diameters and lengths to accommodate different sized basins 134.

Runoff 136 can pass through system 100 prior to exiting the catch basin 134 thereby preventing undesirable materials and contaminants from entering waterways. A first responder can manually set the valve 102 to an open, closed or self-regulating position via the actuator 106 or the actuator 106 can be driven locally by processor 156 or can be controlled remotely via a received control signal generated by an application 166 running on either a smart phone or a personal computer communicating via a wireless communication network 166. In some embodiments a control signal from sensors 124 or a sensor network can activate or deactivate (i.e. open, close or cause to regulate) valve 102. Runoff 136 flowing through the system 100 can pass one or more sensors 124 which can detect substances other than pure water and can activate a mechanism to close the valve 102 in response to detecting such substances that may be dangerous to the waterways. Thus, the output of one or more sensors 124 can be used to open, close or cause the self-regulation of the valve via the actuator 106. The actuator 106 can be driven by microprocessor 156 and which can be housed in the piston 108 or other convenient nearby location.

Sensors 124 can be capable of detecting parameters and measuring phenomena flow, flow rate, PH, turbidity, specific gravity, chemical composition, solids, chemical properties etc. Sensors can be configured as motes which are known in the art of distributed sensing and networking. The presence of such pollutants which might enter the system 100 from littering, spills, traffic accidents etc. can be detected, and send the appropriate signal causing valve 102 to close via actuator 106. Sensors 124 outputs can be transmitted via antenna 162 and wireless network 166 to authorities or those responsible for environmental quality. Wireless network 166 can be implemented via land based or satellite based devices and can be a LAN, WAN or cellular network. Wireless network can report the location transmitting the data using stored location data or a GPS type coordinates. Sensors 124 can have a camera and can stream video and can detect valve position or if the valve 102 is partially or fully open, closed or in a self or automatic regulating position or mode of operation. Sensors 124 can also collect data that can be stored in local memory and sensor data can be periodically read on site or transmitted to an external device such as a smart phone with an RFID as a maintenance vehicle with a receiver passes each system 100. The valve 102 can be quickly and easily removed for servicing and/or a data download and thus can be quickly and efficiently replaced in the field.

Processor 156 can receive software update via wireless network 166 and can perform remote diagnostics on the system 100 or valve 102 and can send this along with the sensor data collected by the system 100. The processor-transceiver 156 can also provide a video link to send pictures, environmental data or video from the basin 134 or drawer 129 during operation. The system 100 can communicate with external devices via, but not limited to, LAN, WAN, radios, cell towers, Bluetooth and RFID technology to name a few via antenna 166 and a remote processor running an application. The system 100 can also communicate using sonic or ultrasonic pressure waves sent through the outlet pipe or pipes system either directly to or via remote repeaters and processors 168 running applications remotely (off site).

In some embodiments, the valve 102 and/or drawer 129 can be removed only with a special key 118 (key 118 shown for valve 102 in FIG. 1, not shown for drawer 129). The key 118 can be configured in different ways such as a metal key 118 or as a magnet such as those used to remove theft deterrent devices from goods by retailers. In some embodiments actuator 106 can be manually operated with a key 118 that is inserted in an opening in a manhole cover 132. Key can prevent unauthorized persons from changing the valve position and from removing the valve body 102 from the basin 134. In some embodiments the actuator 106 can include a motor, a nut and a threaded portion that acts like a servo based system. Other types of actuators 106 such as compressed gas, electric, electrical, electronic, and mechanical or by hydraulic fluid can be used to activate or position the valve 102.

Some advantages of the disclosed embodiments are the ease of installation and serviceability and that it is inexpensive and all parts are field replaceable with ease. The mounting configuration can include a two-dimensional support frame adapted to receive the drawer 129 within the catch basin 134 adjacent to a curb or beneath a grate. The filter 116 can also include a filter bag coupled to the support frame, where the filter bag has an open top adapted to the top edge of the drawer 129 and a closed bottom and bag sidewalls. When installed, the catch basin filter can be placed wholly within the drawer 129 so that when the drawer 129 is removed the bag is easily removed. In some embodiments the pan 238 can extend into the flange area to the valve seat 212 thereby eliminating the need for the mounting flange 214.

Referring to FIG. 2 a system 200 is shown that has a valve stem 204, piston 208, valve guide 210, valve seat 212, mounting flange 214, bottom valve guide mount 226, top valve guide mount 278 and positioner slot 246. The system 200 can have all of the features as described and associated with systems 100 and 300 as described with regard to FIGS. 1 and 3. FIG. 2 has the additional cost advantage of not having a valve body. Thus, the embodiment of FIG. 2 also does not require a seal to be made between a valve body and a mounting flange 214. In the embodiment shown, the valve guide can be held at a bottom edge by a bottom valve guide mount 226 and/or at a top end by a top valve guide mount 278. The valve seat 212 can be manufactured as part of the mounting flange 214 or the valve seat can rest directly onto the bottom of the pan 138 when pan 138 discharge opening is pressed, molded or formed into a seat for valve 208 to seal to when in closed position.

Referring to FIG. 3 a system 300 is shown that has a valve stem 304, actuator 306, piston 308, valve guide 310, valve seat 312, mounting flange 314, valve guide mount 326, pan 338, positioner slot 346, and valve guide mount 378. The system 300 can have all of the features as described and associated with system 100 as described with regard to FIG. 1. FIG. 3 has the additional cost advantage of not having a valve body. Thus, the embodiment of FIG. 3 also does not require a seal to be made between a valve body and a mounting flange 314. In the embodiment shown the valve guide can be held at a bottom edge by a bottom valve guide mount 326 and/or at a top end by a top valve guide mount 378.

Referring to FIG. 4, a system is disclosed that has a valve seat 412 that is integrated in the boom surface of basin 438. The system can include closure member 402, valve stem 404, actuator 406, sensors 408 integrated inside of the body of the closure member 402, valve mount via connection to actuator 410, manual actuator 420, actuator positioner 446, basin or tray 478.

Referring to FIG. 5 is a top view of a basin with a removable pollution catch tray 529. The tray 528 has a cut out or relief such that the catch ray 528 can be slid in to a basin from a curb inlet without interfering with the valve 531. The catch tray can be supported in the basin by drawer or tray slides 554.

The systems 100-500 could implement a hydrocarbon filter system that provides sufficient contact time with runoff at rated flows of passing contaminated water. Under certain circumstances the filter can capture and retain nearly all hydrocarbons that are absorbed by the physical structure of the filter. The filter can be made from polymer based beads or other specialized materials can be contained within the filter. The exterior of the filter can be made of a highly efficient, lipophilic lightweight fiber matrix that adsorbs an average of twenty times its weight of hydrocarbons or vegetable oils yet allows large volumes of water to pass while adsorption of the targeted hydrocarbons begins on contact. Filter can have an exterior made from non-corrosive recycled synthetic fibers. Filter can be extremely efficient due to the enormous lipophilic surface area of the altered fibers.

The filter can be environmentally benign and user-friendly such that it does not leach harmful substances into the environment and when incinerated produces minimal residue or ash. Filter can be durable and have longevity under normal circumstance of more than one year. Filter can be made of sufficient strength to support water, sediment, and debris loads even when the media is at maximum absorption capacity; with no slippage, breaking, or tearing. Thus filter can handle rigorous flow and loading conditions.

Filter can have oil absorbent media that prevents oil from passing through the media. Filter can have a pollutant removal efficiency that can capture high levels of hydrocarbons including but not limited to oils & grease, gasoline, diesel, and other chemical contaminants. The granule nature of the absorbent material has approximately 2 mm sized granules with the physical ability to also block and filter trash, litter, grass, foliage and sediments. Filter can be placed over a valve such that replacement is simple. Filter can be securely installed and can have contact surfaces sufficiently joined together so that no filter bypass will occur at low flow.

Filter System can be used for period that is determined by the amount of hydrocarbon loading present in each installation. The Hydrocarbon Filter System is easily removable from most filter devices. At each cleaning, new hydrocarbon filters should be installed by competent service crews. Systems can incorporate various types of contaminate indicators such as special coatings, photo type or computerized analysis of electromagnetic wave (EMW) frequency absorption or scattering (spectrometry) and/or methods using chemical sensitive paper that turns color when it comes into contact with certain chemicals or substances such as 4, 7 or 10 way test strips or litmus paper of other types of indicating devices such as chemical reaction test kits.

Following maintenance and/or inspection, the maintenance operator shall prepare a maintenance/inspection record. The record shall include any maintenance activities performed, amount and description of debris collected, and condition of filter. The owner or facility director can retain the maintenance/inspection record for purposes of establishing mandated environmental regulation compliance. These records can be made available to the governing municipality, the public and/or federal regulators for inspection upon request at any time. For maintenance and cleaning, old filters can easily be replaced with new and updated ones. Design is such that maintenance can be performed from the ground surface. The color of the filter material can be the indicator of the amount of hydrocarbons present in the filter, i.e., the darker the color the more impacted the Safe Drain® Hydrocarbon Filter System.

### Electronic Monitoring, Databasing and Control

The disclosed embodiments can take the form of an entirely hardware embodiment or an integrated software embodiment containing both hardware and software elements. In a preferred embodiment, the invention is implemented in software, which includes but is not limited to firmware, resident software, microcode, etc. Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. A data processing system suitable for storing and/or executing program code can include at least one processor, logic, or a state machine coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modern and Ethernet cards are just a few of the currently available types of network adapters.

It will be apparent to those skilled in the art having the benefit of this disclosure that the present invention contemplates methods, systems, and media that provide a driver with situational awareness information. It is understood that the form of the invention shown and described in the detailed description and the drawings are to be taken merely as examples. It is intended that the following claims be interpreted broadly to embrace all the variations of the example embodiments disclosed.

What is claimed is:

1. A pollution mitigation system comprising:
a valve body fanning a passage, installable proximate to an orifice in a subsurface storm water retention chamber, the passage and orifice allowing the movement of a substance out of the storm water retention chamber and into an outlet conduit, the valve body to retain a stem coupled to a closure member;
a preloaded actuator coupleable to the closure member, the preloaded actuator biased to keep the closure member in an open position; and
a node comprising at least one sensor, a transceiver, antenna, microcontroller, memory, an energy source and at least one output, all coupled to the preloaded actuator, the least one output to provide a stimulus to the preloaded actuator to cause the preloaded actuator to move the closure member to a position that obstructs the passage in response to the stimulus.

2. The system of claim 1, wherein the node is part of a wireless sensor network.

3. The system of claim 2 where the wireless sensor network is a multi-hop wireless mesh network.

4. The system of claim 1, wherein the sensor has a second at least one output and wherein the second at least one output is coupled to the preloaded actuator and wherein the preloaded actuator to move the closure member to a position that obstructs the passage in response to a stimulus on the second at least one output.

5. The system of claim 1 wherein the at least one sensor to detect a phenomena and wake up the node.

6. The system of claim 1 wherein the at least one sensor to detect the presence of one of water, a petroleum based substance, and a heavy metal.

7. The system of claim 1 wherein the sensor is a chemical agent detector.

8. The system of claim 1 wherein the sensor is an Ion-mobility spectrometry type sensor.

9. The system of claim 1 wherein the sensor is a mass spectrometry type sensor.

10. The system of claim 1 wherein the sensor is a high-performance liquid chromatography type sensor.

11. The system of claim 1, wherein transceiver configurable to communicate via one of an IEEE 802. Compliant protocol, Bluetooth, GPRS, Wi-Fi, Global Positioning System (GPS) and a cellular type communication network.

12. The system of claim 1, wherein communication with the node and the activation of the preloaded actuator can be performed using an application downloaded onto a smartphone platform.

13. The system of claim 1 further comprising storing sensor data and relaying the sensor data to other nodes in the system.

14. The system of claim 1 further comprising performing imagery defined materials intelligence in connection with chemical defined materials intelligence thereby measuring ions and analyzing pixels to identify a composition of at least one substances passing through the valve.

15. The system of claim 1 further comprising a sample retention chamber at one of a high water level location, a mid-water level location and proximate to a lowest location of the subsurface storm water retention chamber.

16. The system of claim 15 further comprising a sample extraction conduit in communication with at least one sample retention chamber.

17. The system of claim 1 further comprising a removable filter coupled to the sensor such that the sensor can generate information associated with the removable filter.

18. The system of claim 17 wherein the removable filter further comprises:
a unique identifier; and
one of an absorbing agent that absorbs one of chemicals or liquids other than water or an agent that is dispersed in response to the detection of a predetermined parameter.

19. A pollution mitigation system comprising:
a valve body installable in a storm water catch basin;
a valve stem coupled to the valve body;
a closure member coupled to the valve stem
a valve seat coupled to the valve body to form a sealable surface with the closure member;
a networkable sensor coupled to the valve body to sense a position of the closure member and conditions within the storm water catch basin;
a prebias-able actuator mechanism that has a pre-biased open setting, a locked open setting, a closed spring pressure based setting, a locked closed setting and a regulatory setting wherein when the actuator is in the regulatory setting the valve regulates a height of water in a chamber above the valve such that floating debris is substantially prevented from passing through the valve body, the valve disposed below the storm water catch basin such that minimal water is retained in the storm water catch basin a predetermine amount of time after storm water runoff ceases to enter the storm water catch basin.

20. A pollution mitigation system comprising:
a valve having a prebias-able closure actuator installable storm water catch basin; and
a networkable sensor that can sense contamination in the storm water catch basin and a position of the actuator, wherein the sensor has an output that can control a position of the actuator in real time based on conditions sensed within the storm water catch basin and based on receiving a command via at wireless network communication wherein the valve is positioned in the vault such that minimal water is retained in the storm water catch basin a predetermined amount of time after storm water runoff ceases to enter the storm water catch basin.
